(19) United States
(12) Patent Application Publication
(10) Pub. No.: US 2025/0318019 A1
(43) Pub. Date: Oct. 9, 2025

(54) HEATING APPARATUS

(71) Applicant: NITERRA CO., LTD., Nagoya-shi (JP)

(72) Inventors: Hiroki HATTORI, Nagoya-shi (JP); Toshihiro MITANI, Nagoya-shi (JP)

(73) Assignee: NITERRA CO., LTD., Nagoya-shi (JP)

(21) Appl. No.: 19/095,322

(22) Filed: Mar. 31, 2025

(30) Foreign Application Priority Data
Apr. 5, 2024 (JP) 2024-061370
Oct. 22, 2024 (JP) 2024-186010

(51) Int. Cl. H05B 3/48; H05B 1/02; H05B 3/00; H05B 3/04

(52) U.S. Cl. CPC H05B 3/48; H05B 1/0236; H05B 3/0019; H05B 3/04; H05B 2203/021; H05B 2203/035

(57) ABSTRACT

A heating apparatus includes a ceramic heater which includes a tubular ceramic base body and a wire-like resistive heating element embedded in the ceramic base body. The ceramic heater has a base portion, on which a first electrode connected to one end of the resistive heating element and a second electrode connected to the other end of the resistive heating element are formed, and a heating portion heated by the resistive heating element. The heating apparatus also includes a first electricity conducting member connected to the first electrode, a second electricity conducting member connected to the second electrode, and a housing which accommodates the ceramic heater. The housing has a first space for accommodating the heating portion and a second space for accommodating the base portion. The second space is filled with a seal member.

### BACKGROUND

### Technical Field

The present disclosure relates to a heating apparatus.

### Description of the Related Art

A ceramic heater having a ceramic base body including a resistive heating element embedded therein is used in a variety of applications, because it is compact and lightweight, and has excellent insulating and temperature raising performance. JP2023-160310A discloses a heating apparatus which heats a medium such as a liquid by a ceramic heater.

In the case where a medium is heated by a heating apparatus including a ceramic heater, the interior of the heating apparatus comes into a high-temperature state as a result of heating of the medium. In addition, in the case where a heating apparatus is mounted in, for example, a vehicle, there is a possibility that the external environment is humid, and in such a case, external moisture enters the heating apparatus, and the interior of the heating apparatus comes into a humid state. When the ceramic heater is energized in such a high-temperature, humid state, ion migration may occur between a pair of electricity conducting members for supplying electric power to the ceramic heater. If ion migration occurs, a short circuit is formed between the pair of electricity conducting members, which may cause damage to, for example, a control circuit board for controlling the electric power supplied to the ceramic heater.

### SUMMARY

The object of the present disclosure is to solve the above-described problem. Namely, one object of the present disclosure is to suppress occurrence of ion migration during operation of a heating apparatus including a ceramic heater.

A heating apparatus (1) according to the present disclosure comprises:
a ceramic heater (10) including a tubular ceramic base body and a resistive heating element embedded in the ceramic base body, the ceramic heater having a base portion (111), on which a first electrode (13) connected to one end of the resistive heating element and a second electrode (14) connected to the other end of the resistive heating element are formed, and a heating portion (112) heated by the resistive heating element;
a first electricity conducting member (61) connected to the first electrode (13);
a second electricity conducting member (62) connected to the second electrode (14); and
a housing (20) which accommodates the ceramic heater (10).

The housing (20) has a first space (S1) for accommodating the heating portion (112) and a second space (S2) for accommodating the base portion (111). Then, the second space (S2) is filled with a seal member.

In the heating apparatus according to the present disclosure, the second space of the housing is filled with the seal member. The base portion of the ceramic heater is disposed in the second space, a pair of electrodes (the first electrode and the second electrode) are formed on the surface of the base portion, and a pair of electricity conducting members (the first electricity conducting member and the second electricity conducting member) are connected to the pair of electrodes. Accordingly, the base portion of the ceramic heater disposed in the second space, the pair of electrodes (the first electrode and the second electrode), and the pair of electricity conducting members (the first electricity conducting member and the second electricity conducting member) are sealed by the seal member which fills the second space. By virtue of this, the insulation of the pair of electricity conducting members is secured, and moisture around them is removed. Therefore, it is possible to prevent the second space from becoming a high-humidity state, thereby suppressing occurrence of ion migration between the pair of electricity conducting members.

Notably, the pair of electricity conducting members (the first electricity conducting member and the second electricity conducting member) are connected to a power supply source such as a control circuit board so as to apply a predetermined voltage between the pair of electrodes. Since the power supply source is not disposed in the second space, the pair of electricity conducting members have portions disposed in the second space and portions not disposed in the second space. Accordingly, among the portions of the pair of electricity conducting members, the portions not disposed in the second space are not embedded in the seal member. However, ion migration occurs at portions of the electricity conducting members, which portions are located near the electrodes. Since the portions located near the electrodes are disposed in the second space, these portions are embedded in the seal member. Therefore, occurrence of ion migration can be suppressed to a sufficient degree, although the remaining portions of the electricity conducting members are not embedded in the seal member.

In the present specification, the term “seal member” refers to a solid member in which a member disposed in a space is buried, whereby that member can be insulated, and air can be removed around that member. Preferably, the seal member has low hygroscopicity and high insulating performance. Typically, a potting agent is used as the seal member. Use of a potting agent as the seal member makes it easy to dispose the seal member in the second space. However, since use of a potting agent having high hygroscopicity brings about the possibility of occurrence of ion migration through the potting agent, the potting agent used should not be one that has high hygroscopicity.

In one mode of the heating apparatus according to the present disclosure, the heating apparatus (1) comprises a fixing member (40) for fixing the ceramic heater (10) to the housing (20). The fixing member (40) has a surrounding portion (42) which is disposed in the second space (S2) and is configured to surround the base portion (111), the first electricity conducting member (61), and the second electricity conducting member (62). A surrounded space (S21), which is an internal space of the surrounding portion (42), is filled with the seal member.

In the above-described configuration, since the space (surrounded space) inside the surrounding portion is filled with the seal member, it is possible to suppress occurrence of ion migration between the first electricity conducting member and the second electricity conducting member which are disposed in the surrounded space.

In another mode of the heating apparatus according to the present disclosure, the ceramic heater (10) has a circular tubular portion (11) in which the base portion (111) and the heating portion (112) are continuously formed in an axial direction, and a flange portion (12) which extends outward in a radial direction of the circular tubular portion (11) from a boundary between the base portion (111) and the heating portion (112). In addition, a stepped wall portion (24) is provided between the first space (S1) and the second space (S2) of the housing (20). The stepped wall portion (24) has a circular hole (244) which establishes communication between the first space (S1) and the second space (S2) and has a diameter smaller than an outer diameter of the flange portion (12). The flange portion (12) butts against the stepped wall portion (24), thereby separating the first space (S1) and the second space (S2) from each other.

In the above-described configuration, the first space and the second space within the housing can be separated from each other by the flange portion of the ceramic heater.

In still another mode of the heating apparatus according to the present disclosure, the ceramic heater (10) is disposed in the housing (20) such that an axial direction of the circular tubular portion (11) coincides with a first direction (forward/rearward direction). The surrounding portion (42) has a pair of opposing portions (421) disposed to face each other such that the opposing portions are spaced from each other in a second direction (leftward/rightward direction) perpendicular to the first direction (forward/rearward direction) and cover the base portion (111) from opposite sides, a connecting portion (422) which connects together end portions (forward end portions) of the opposing portions (421) located on one side in the first direction (forward/rearward direction), and a bottom portion (423) which closes an opening surrounded by end portions (lower end portions) of the pair of opposing portions (421) and an end portion (lower end portion) of the connecting portion (422), the end portions being located on one side in a third direction (upward/downward direction) perpendicular to the first direction (forward/rearward direction) and the second direction (leftward/rightward direction). The surrounded space (S21) is a space surrounded by the pair of opposing portions (421), the connecting portion (422), and the bottom portion (423).

The above-described configuration enables injection of the seal member into the surrounded space surrounded by the pair of opposing portions, the connecting portion, and the bottom portion of the surrounding portion.

In still another mode of the heating apparatus according to the present disclosure, the fixing member (40) has a restraining portion (43) formed to extend in directions (leftward/rightward direction and upward/downward direction) perpendicular to the first direction (forward/rearward direction) from end portions (rear end portions) of the pair of opposing portions (421) and an end portion (rear end portion) of the bottom portion (423), the end portions being located on the other side in the first direction (forward/rearward direction). The ceramic heater (10) is fixed by the fixing member (40) as a result of butting of the restraining portion (43) against the flange portion (12).

By virtue of the above-described configuration, the ceramic heater can be fixed in the housing by the fixing member. In addition, since the restraining portion butts against the flange portion, the surrounded space is surrounded by the pair of opposing portions, the connecting portion, the bottom portion, and the flange portion. Therefore, in the case where the surrounded space is a space having an approximately cuboid-shape, the surrounded space is surrounded by the above-described portions from five directions. Therefore, the surrounded space communicates with the external space only in one direction (i.e., on the open side). Therefore, the seal member can be kept in the surrounded space by injecting the seal member into the surrounded space from the open side.

In still another mode of the heating apparatus according to the present disclosure, the fixing member (40) has a tubular inlet passage portion (41) having one end which is open through the connecting portion (422), the inlet passage portion extending in a direction opposite the surrounded space (S21). The base portion (111) disposed in the surrounded space (S21) is connected to one end of the inlet passage portion (41), whereby communication is established between an internal space of the inlet passage portion (41) and an internal space of the base portion (111).

By virtue of the above-described configuration, a medium can be caused to flow from the inlet passage portion of the fixing member into the internal spaces of the base portion and the heating portion of the ceramic heater and can be introduced from the heating portion into the first space of the housing.

In still another mode of the heating apparatus according to the present disclosure, the housing (20) has a third space (S3) separated from the first space (S1), and a control circuit board (30) for controlling energization of the resistive heating element is disposed in the third space (S3). The first electricity conducting member (61) and the second electricity conducting member (62) extend from the first electrode (13) and the second electrode (14), respectively, toward the control circuit board (30), and their distal end portions are connected to the control circuit board (30).

By virtue of the above-described configuration, the control circuit board can be accommodated in the heating apparatus, and the pair of electricity conducting members (the first electricity conducting member and the second electricity conducting member) can be connected to the control circuit board.

In still another mode of the heating apparatus according to the present disclosure, the housing (20) has an outlet passage portion (27) through which a medium flows out from the first space (S1). The heating apparatus (1) comprises a first temperature sensor (71) for detecting the temperature of the medium flowing through the inlet passage portion (41) and a second temperature sensor (72) for detecting the temperature of the medium flowing through the outlet passage portion (27). A signal representing the temperature detected by the first temperature sensor (71) and a signal representing the temperature detected by the second temperature sensor (72) are sent to the control circuit board (30).

By virtue of the above-described configuration, the control circuit board can control energization of the resistive heating element on the basis of the temperature detected by the first temperature sensor or the temperature detected by the second temperature sensor.

In still another mode of the heating apparatus according to the present disclosure, the seal member is a potting agent whose main component is an olefin-based resin, an epoxy-based resin, or a special polymer containing a silyl group.

The potting agent mentioned above is low in hygroscopicity and high in insulating performance. Accordingly, occurrence of ion migration can be suppressed to a sufficient degree by using the above-mentioned potting agent as the seal member. In still another mode of the heating apparatus according to the present disclosure, the heating apparatus (1) is used to heat a medium flowing through a flow passage formed in an apparatus mounted in a vehicle.

By virtue of the above-described configuration, it is possible to heat a medium flowing through a flow passage formed in an apparatus mounted in a vehicle; for example, a refrigerant flowing through a refrigerant circuit of a vehicle air conditioner or a temperature control fluid flowing through a flow passage formed in a temperature control apparatus for a vehicle battery.

### BRIEF DESCRIPTION OF THE DRAWINGS

FIG. 1A is a perspective view of a heating apparatus according to an embodiment;

FIG. 1B is a plan view of the heating apparatus;

FIG. 2 is an exploded perspective view of the heating apparatus;

FIG. 3 is a sectional view of the heating apparatus taken along a line III-III in FIG. 1A;

FIG. 4 is a sectional view of the heating apparatus taken along a line IV-IV in FIG. 3;

FIG. 5 is a view of a circular tubular portion as viewed from the upward side;

FIG. 6 is a view of the circular tubular portion as viewed from the right side;

FIG. 7 is a sectional view of a housing shown in FIG. 3;

FIG. 8 is a sectional view of the housing shown in FIG. 4;

FIG. 9 is a schematic view of the housing of FIG. 8 as viewed from the side indicted by an arrow A;

FIG. 10 is an enlarged view of a portion B of FIG. 3; and

FIG. 11 is an enlarged view of a portion C of FIG. 4.

### DESCRIPTION OF THE PREFERRED EMBODIMENT

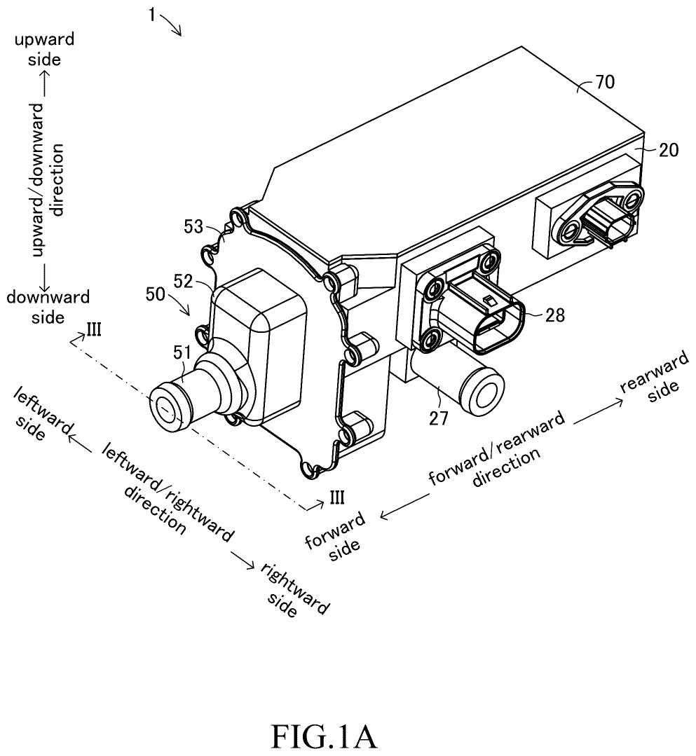

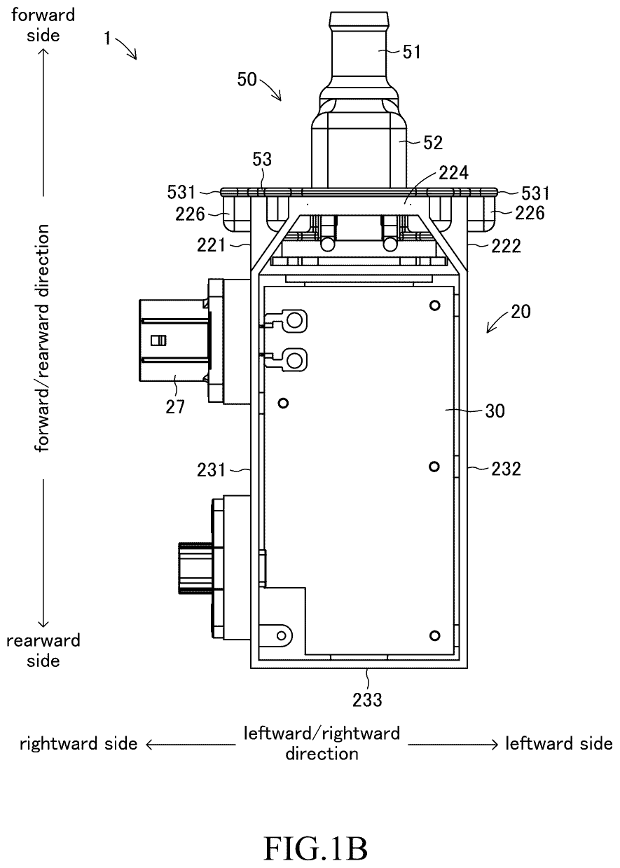

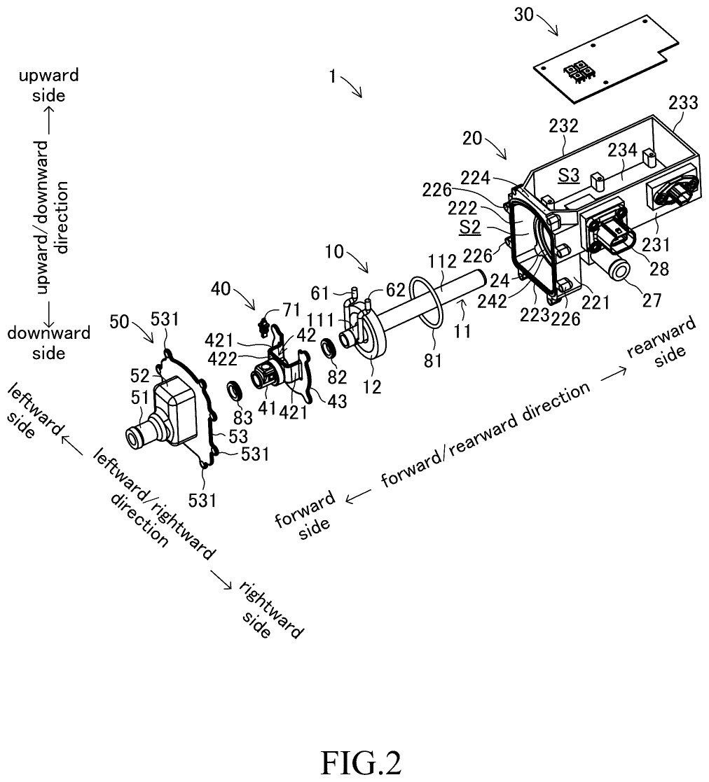

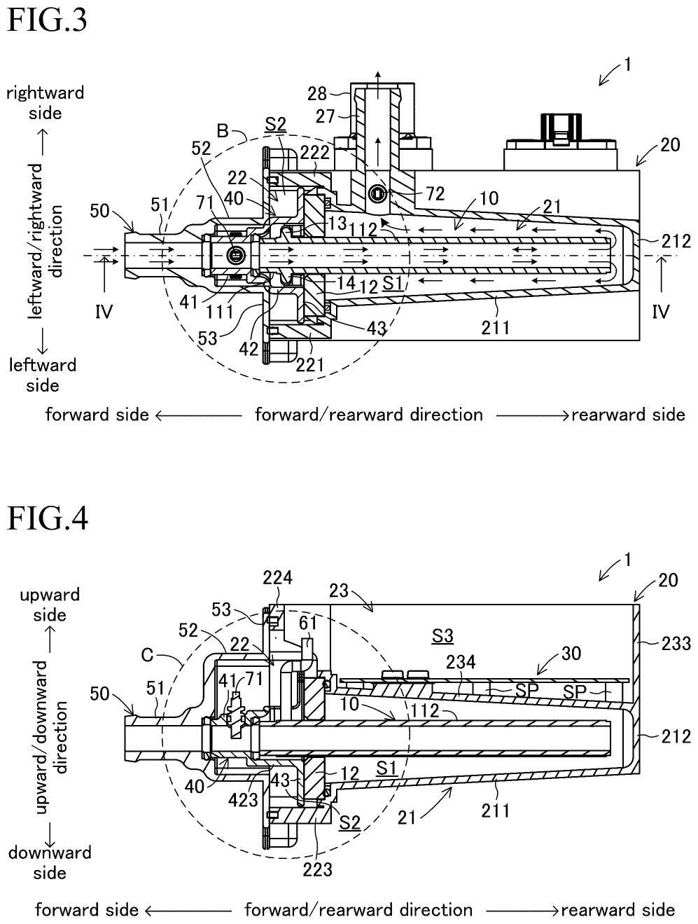

An embodiment of the present disclosure will now be described with reference to the drawings. FIG. 1A is a perspective view of a heating apparatus 1 according to the present embodiment, and FIG. 1B is a plan view of the heating apparatus 1. FIG. 2 is an exploded perspective view of the heating apparatus 1, FIG. 3 is a sectional view of the heating apparatus 1 taken along a line III-III in FIG. 1A, and FIG. 4 is a sectional view of the heating apparatus 1 taken along a line IV-IV in FIG. 3. When the heating apparatus 1 and its constituent components are described with reference to these and other drawings, a forward/rearward direction (a first direction), a leftward/rightward direction (a second direction), and an upward/downward direction (a third direction) shown in FIG. 1A are used. These directions are perpendicular to one another. One side in the forward/rearward direction will be referred to as the “forward side,” and the other side in the forward/rearward direction will be referred to as the “rearward side.” One side in the leftward/rightward direction will be referred to as the “right side,” and the other side in the leftward/rightward direction will be referred to as the “left side.” One side in the upward/downward direction will be referred to as the “upward side,” and the other side in the upward/downward direction will be referred to as the “downward side.” When the constituent components of the heating apparatus 1 are individually described, the constituent components are described by using their directions shown in FIGS. 1A and 1B in a state in which the constituent components are incorporated in the heating apparatus 1. Notably, an upper plate 70 shown in FIG. 1A is shown only in FIG. 1A and is not shown in other drawings.

The heating apparatus 1 according to the present embodiment may be mounted in a vehicle. The heating apparatus 1 may be used to heat a medium flowing through a flow passage formed in an apparatus mounted in the vehicle. Examples of the apparatus mounted in the vehicle include a vehicle air conditioner and a vehicle battery. Examples of the flow passage formed in the apparatus mounted in the vehicle include a refrigerant circuit of the vehicle air conditioner, and a flow passage formed in a temperature control apparatus for controlling the temperature of the vehicle battery. Examples of the medium flowing through the flow passage formed in the apparatus mounted in the vehicle include a refrigerant flowing through the refrigerant circuit of the vehicle air conditioner and a temperature control fluid flowing through the flow passage formed in the temperature control apparatus for the vehicle battery. Notably, in the present specification, “medium” is a general term for fluids used to transfer heat. In the following, an example in which a liquid such as liquid refrigerant or cooling water is used as a medium will be described.

As shown in FIG. 2, the heating apparatus 1 includes a ceramic heater 10, a housing 20, a control circuit board 30, a fixing bracket 40, and an inlet plate 50.

The ceramic heater 10 has a circular tubular portion 11 and a flange portion 12. The circular tubular portion 11 has the shape of a circular tube whose opposite ends are open. The flange portion 12 having a ring-like shape is fixed to an outer peripheral wall surface of the circular tubular portion 11 to be coaxial with the circular tubular portion 11.

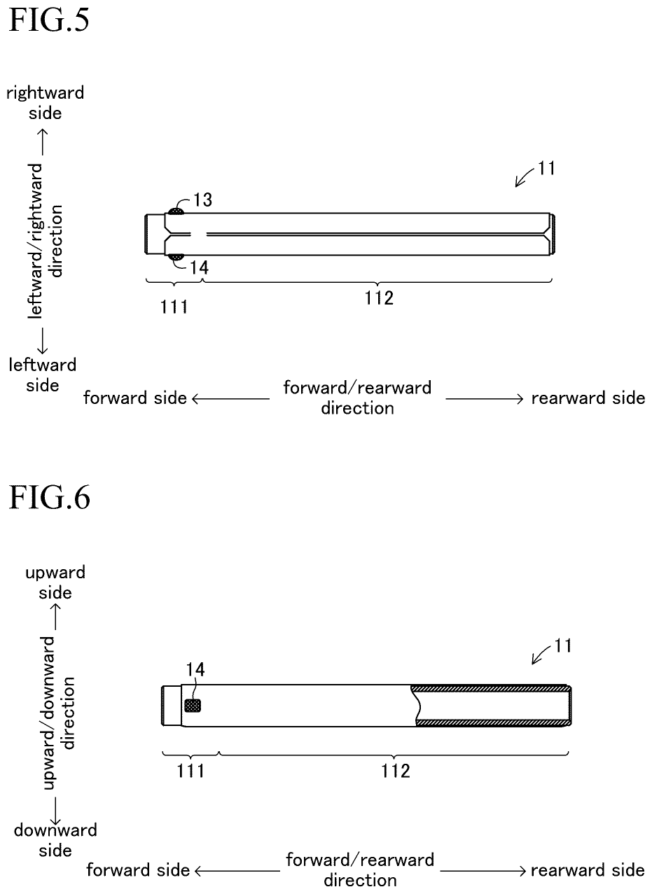

FIG. 5 is a view of the circular tubular portion 11 as viewed from the upward side, and FIG. 6 is a view of the circular tubular portion 11 as viewed from the right side. In FIG. 6, the circular tubular portion 11 is partially sectioned. The circular tubular portion 11 includes a resistive heating element and a ceramic base body. The resistive heating element is a wire-like member which generates heat upon energization and is formed by a long conducting wire such that it has a predetermined pattern. An example of the resistive heating element is a tungsten wire. The resistive heating element is embedded in the ceramic base body having a cylindrical tubular shape. The ceramic base body is a member for heating an object to be heated and is heated by the resistive heating element embedded therein. The ceramic base body is formed of a ceramic material. The ceramic base body is formed of, for example, alumina.

The circular tubular portion 11 can be manufactured, for example, as follows. A resistive heating element formed into a predetermined pattern is sandwiched by two ceramic green sheets so as to form a laminate, and the laminate is wound around a circular tubular ceramic body. Subsequently, the ceramic body with the laminate wound therearound is fired. Thus, the circular tubular portion 11 having the ceramic base body and the resistive heating element embedded therein can be manufactured.

As shown in FIGS. 5 and 6, the circular tubular portion 11 has a base portion 111 and a heating portion 112. The base portion 111 is formed in a region which includes an end portion of the circular tubular portion 11 on the forward side. The heating portion 112 is the remaining portion of the circular tubular portion 11; i.e., a potion other than the base portion 111. The base portion 111 and the heating portion 112 are formed continuously in the axial direction. The length of the heating portion 112 in the axial direction is greater than that of the base portion 111.

A first electrode pad 13 (a first electrode) and a second electrode pad 14 (a second electrode) are formed on an outer circumferential surface of the base portion 111. Both the first electrode pad 13 and the second electrode pad 14 are formed of an electrically conductive material such as metal. One end of a first electricity conducting member 61 shown in FIG. 2 is connected to the first electrode pad 13. One end of a second electricity conducting member 62 shown in FIG. 2 is connected to the second electrode pad 14. For example, the first electricity conducting member 61 and the second electricity conducting member 62 are lead terminals. The other end of the first electricity conducting member 61 and the other end of the second electricity conducting member 62 are electrically connected to predetermined locations of the control circuit board 30.

The resistive heating element of the circular tubular portion 11 is embedded in the ceramic base body having a circular tubular shape such that the resistive heating element forms a predetermined pattern mainly in the heating portion 112. Accordingly, the heating portion 112 is a portion heated by the resistive heating element. Opposite end portions of the resistive heating element are extended to the base portion 111, and the end portions of the resistive heating element are respectively connected to the first electrode pad 13 and the second electrode pad 14 formed on the outer circumferential surface of the base portion 111. Accordingly, when a predetermined voltage is applied between the first electrode pad 13 (the first electricity conducting member 61) and the second electrode pad 14 (the second electricity conducting member 62), the resistive heating element is energized (current flows through the resistive heating element).

The flange portion 12 is formed of a ceramic material into a ring-like shape. The flange portion 12 may be formed of the same material as the ceramic base body which constitutes the circular tubular portion 11. For example, the flange portion 12 may be formed of alumina. The flange portion 12 is joined to the circular tubular portion 11 by means of, for example, brazing. The flange portion 12 extends outward in a radial direction of the circular tubular portion 11 from the boundary between the base portion 111 and the heating portion 112 of the circular tubular portion 11. Accordingly, the circular tubular portion 11 is divided into the base portion 111 and the heating portion 112 by the flange portion 12.

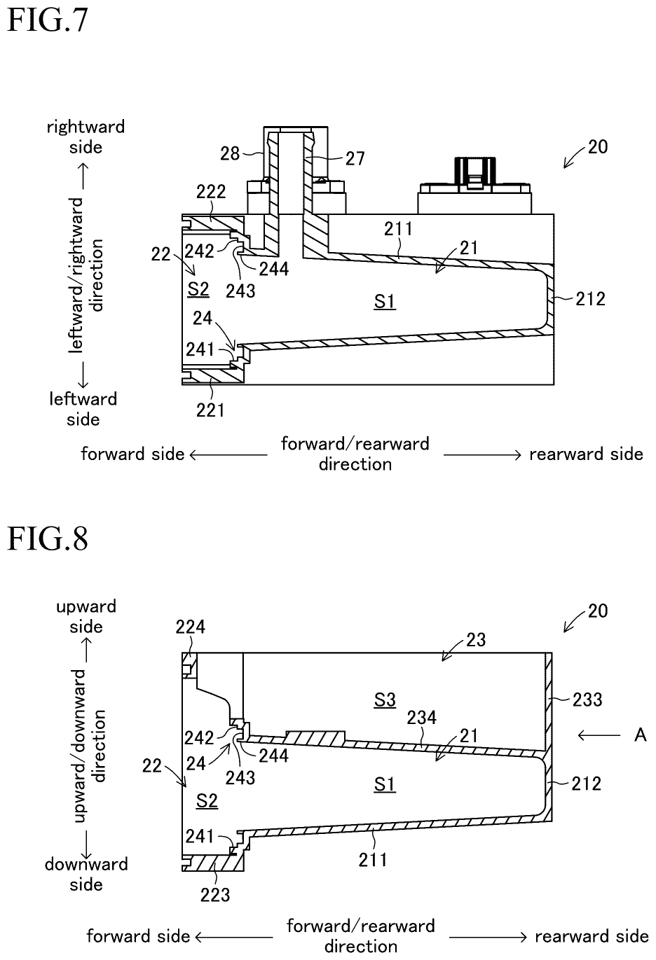

The housing 20 functions as a container for accommodating the ceramic heater 10 and the control circuit board 30 and defines a flow passage of a liquid to be heated by the heating apparatus 1. FIG. 7 is a sectional view of the housing 20 shown in FIG. 3, and FIG. 8 is a sectional view of the housing 20 shown in FIG. 4.

As shown in FIGS. 7 and 8, the housing 20 has a heating chamber 21 (a first chamber), an electric power supply chamber 22 (a second chamber), and a circuit board accommodating chamber 23 (a third chamber). A first space S1 is defined in the heating chamber 21, a second space S2 is defined in the electric power supply chamber 22, and a third space S3 is defined in the circuit board accommodating chamber 23. Namely, the first space S1, the second space S2, and the third space S3 are defined in the housing 20. The first space S1 is a space in which the heating portion 112 of the ceramic heater 10 is accommodated, and a flow passage of a liquid (an object to be heated) is formed. The second space S2 is a space in which the base portion 111 and the flange portion 12 of the ceramic heater 10 are accommodated. The third space S3 is a space in which the control circuit board 30 is accommodated.

As shown in FIG. 2, the second space S2 is a space which is defined in a forward potion of the housing 20 and communicates with the external space at its forward end. The electric power supply chamber 22, which defines the second space S2, has a right-forward wall portion 221, a left-forward wall portion 222, a bottom wall portion 223, and an upper wall portion 224. The right-forward wall portion 221 and the left-forward wall portion 222 are wall members which are disposed to face each other such that they are spaced from each other in the leftward/rightward direction and which have surfaces perpendicular to the leftward/rightward direction (surfaces extending in the forward/rearward direction and the upward/downward direction). The bottom wall portion 223 is formed into the shape of a flat plate so as to connect together the lower end side of the right-forward wall portion 221 and the lower end side of the left-forward wall portion 222. The upper wall portion 224 is formed so as to connect together the upper end side of the right-forward wall portion 221 and the upper end side of the left-forward wall portion 222. The second space S2 is the space surrounded by these wall portions.

The third space S3 is a space which is defined in an upward portion of the housing 20 and communicates with the external space at its upward end. The circuit board accommodating chamber 23, which defines this third space S3, has a right-rearward wall portion 231, a left-rearward wall portion 232, a rear wall portion 233, and a partition wall portion 234. Ther right-rearward wall portion 231 and the left-rearward wall portion 232 are wall members which are disposed to face each other such that they are spaced from each other in the leftward/rightward direction and which have surfaces perpendicular to the leftward/rightward direction. The length of the right-rearward wall portion 231 in the upward/downward direction is smaller than that of the right-forward wall portion 221, and the length of the left-rearward wall portion 232 in the upward/downward direction is smaller than that of the left-forward wall portion 222.

The right-rearward wall portion 231 is formed integrally with an upper half portion of the right-forward wall portion 221 such that the right-rearward wall portion 231 extends rearward from the rear end of the upper half portion of the right-forward wall portion 221. The left-rearward wall portion 232 is formed integrally with an upper half portion of the left-forward wall portion 222 such that the left-rearward wall portion 232 extends rearward from the rear end of the upper half portion of the left-forward wall portion 222. The rear wall portion 233 is a wall member which is formed into the shape of a flat plate so as to connect together the rear end side of the right-rearward wall portion 231 and the rear end side of the left-rearward wall portion 232 and which has surfaces perpendicular to the forward/rearward direction (surfaces extending in the leftward/rightward direction and the upward/downward direction). The partition wall portion 234 is formed into the shape of a flat plate so as to close an opening formed by the lower end side of the right-rearward wall portion 231, the lower end side of the left-rearward wall portion 232, and the lower end side of the rear wall portion 233. The third space S3 is the space surrounded by these wall portions.

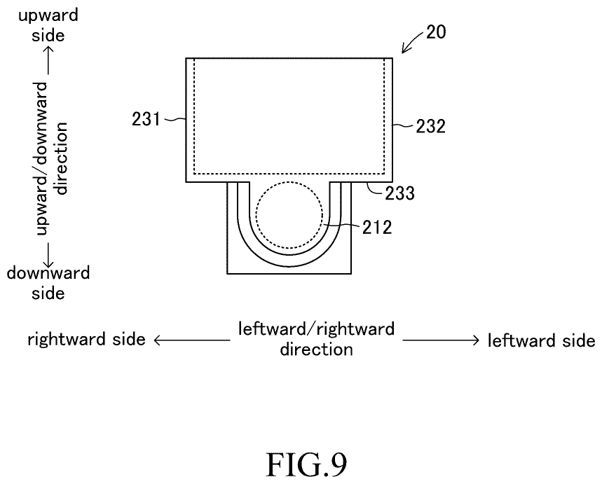

The first space S1 is defined on the rearward side of the second space S2 to be located on the downward side of the third space S3. As shown in FIGS. 7 and 8, the first space S1 has an axis parallel to the forward/rearward direction and has a truncated conical shape such that its diameter decreases toward the rearward side. The heating chamber 21, which defines the first space S1 having such a shape, has a peripheral wall portion 211 and a tip wall portion 212. The peripheral wall portion 211 is a wall member which defines the side circumference of the truncated conical first space S1 by its inner circumferential surface. An upper portion of the peripheral wall portion 211 is connected to the lower end of the partition wall portion 234 of the circuit board accommodating chamber 23. The tip wall portion 212 is a wall member which has surfaces perpendicular to the forward/rearward direction and which defines the top of the truncated conical first space S1 by its front surface. FIG. 9 is a schematic view of the housing 20 as viewed in the direction indicated by an arrow A in FIG. 8. As shown in FIG. 9, the tip wall portion 212 generally has the shape of a semi circle as viewed from the rearward side, which is a lower half of a circle. An upper portion of the tip wall portion 212 is integrally connected to a lower end portion of the rear wall portion 233 of the circuit board accommodating chamber 23.

As shown in FIGS. 3 and 7, an outlet passage portion 27 is formed on the peripheral wall portion 211 of the heating chamber 21 of the housing 20. The outlet passage portion 27 is formed into a tubular shape such that the outlet passage portion 27 protrudes rightward from a predetermined position located on the rightward side of a forward part of the peripheral wall portion 211. The outlet passage portion 27 is a piping member through which the liquid within the first space S1 is caused to flow. As shown in FIG. 3, an outlet temperature sensor 72 is attached to the outlet passage portion 27. The outlet temperature sensor 72 detects the temperature of the liquid flowing inside the outlet passage portion 27 and sends a signal representing the detected temperature to the control circuit board 30.

As shown in FIGS. 7 and 8, a stepped wall portion 24 is formed at a rear end portion of each of the right-forward wall portion 221, the left-forward wall portion 222, and the bottom wall portion 223, which constitute the electric power supply chamber 22. The stepped wall portion 24 is formed between the first space S1 and the second space S2. The stepped wall portion 24 has an inner circumferential wall surface 241 and a seating surface 242. The inner circumferential wall surface 241 is a circular tubular inner wall surface having an axis in the forward/rearward direction, and its diameter is approximately equal to the outer diameter of the flange portion 12. The seating surface 242 is formed to extend radially inward from the rear end of the inner circumferential wall surface 241. The seating surface 242 is a ring-shaped wall surface which faces toward the forward side. An O-ring groove 243 is formed on the seating surface 242. An O-ring 81 (see FIG. 2) is fitted into the O-ring groove 243. In addition, a circular hole 244 is formed radially inward of the ring-shaped seating surface 242. The diameter of the circular hole 244 is smaller than the outer diameter of the flange portion 12. The opening surface of the circular hole 244 defines the bottom surface (forward surface) of the first space S1 having a truncated conical shape. Accordingly, the first space S1 communicates with the second space S2 through the circular hole 244.

As shown in FIG. 8, a gap is formed between an upper portion of the stepped wall portion 24 and the upper wall portion 224, and the second space S2 communicates with the third space S3 through the gap. The third space S3 is liquid-tightly separated from the first space S1 by the partition wall portion 234.

As shown in FIG. 4, the control circuit board 30 is accommodated in the third space S3 of the housing 20. In the third space S3, the control circuit board 30 is horizontally disposed on the partition wall portion 234 of the circuit board accommodating chamber 23 via spacers SP. The control circuit board 30 is a control apparatus for controlling energization of the resistive heating element.

The ceramic heater 10 is accommodated in the first space S1 and the second space S2 of the housing 20. When the ceramic heater 10 is accommodated in the housing 20, the ceramic heater 10 is inserted into the housing 20 through a forward end opening of the second space S2. At that time, the ceramic heater 10 is inserted into the second space S2 the rear end of the heating portion 112 first. The heating portion 112 of the ceramic heater 10 is further inserted to the first space S1 through the circular hole 244 of the stepped wall portion 24. An outer peripheral portion of the rear end surface of the flange portion 12 butts against the seating surface 242 of the stepped wall portion 24 in a state in which a rear portion of the flange portion 12 of the ceramic heater 10 is engaged with the inner circumferential wall surface 241 of the stepped wall portion 24 of the housing 20. Thus, the flange portion 12 is fixedly engaged with the stepped wall portion 24. As a result, the ceramic heater 10 is disposed in the housing 20 such that the axial direction of the circular tubular portion 11 of the ceramic heater 10 coincides with the forward/rearward direction. In this case, as can be seen from FIGS. 3 and 4, the heating portion 112 of the ceramic heater 10 is accommodated in the first space S1, and the base portion 111 and the flange portion 12 of the ceramic heater 10 are accommodated in the second space S2. In addition, the ceramic heater 10 is inserted into the housing 20 in such a manner that the first electrode pad 13 and the second electrode pad 14 provided on the base portion 111 of the ceramic heater 10 are spaced from each other in the leftward/rightward direction. At that time, the first electricity conducting member 61, which is connected, at its one end, to the first electrode pad 13, and the second electricity conducting member 62, which is connected, at its one end, to the second electrode pad 14, extend from the respective electrode pads 13 and 14, upward and rearward, toward the control circuit board 30 in the third space S3. The other end (distal end) of the electricity conducting member 61 and the other end (distal end) of the electricity conducting member 62 enter the third space S3 through the gap between the stepped wall portion 24 and the upper wall portion 224 and are electrically connected to the predetermined locations of the control circuit board 30 in the third space S3, respectively. In this case, the first electricity conducting member 61 and the second electricity conducting member 62 may be directly connected to the predetermined locations of the control circuit board 30, or connected to the predetermined locations of the control circuit board 30 via other electricity conducting members.

The fixing bracket 40 is provided to fix the ceramic heater 10 to the housing 20. As shown in FIG. 2, the fixing bracket 40 has an inlet passage portion 41, a surrounding portion 42, and a restraining portion 43.

The inlet passage portion 41 is formed into the shape of a circular tube having a forward end opening and a rear end opening. As shown in FIG. 2, the surrounding portion 42 has a pair of opposing portions 421 and a connecting portion 422. The pair of opposing portions 421 are plate-shaped portions which are disposed to face each other such that they are spaced from each other in the leftward/rightward direction and each of which has surfaces perpendicular to the leftward/rightward direction (surfaces extending in the upward/downward direction and the forward/rearward direction). The connecting portion 422 is a plate-shaped portion which connects together the forward end sides of the pair of opposing portions 421. The surrounding portion 42 has a bottom portion 423 (see FIG. 4). The bottom portion 423 is a plate-shaped portion configured to close an opening surrounded by lower end portions of the pair of opposing portions 421 and a lower end portion of the connecting portion 422. The bottom portion 423 is formed into the shape of a plate which extends rearward from the lower end side of the connecting portion 422 and has surfaces perpendicular to the upward/downward direction. The left and right sides of the bottom portion 423 are connected to the lower end sides of the pair of opposing portions 421, respectively. The pair of opposing portions 421, the connecting portion 422, and the bottom portion 423 define an approximately cuboid-shaped space (surrounded space) in the surrounding portion 42 such that the surrounded space communicates with the external space on the upward side and on the rearward side.

The rear end of the inlet passage portion 41 is open through the connecting portion 422. The inlet passage portion 41 is formed to extend from the position where the inlet passage portion 41 is open through the connecting portion 422, toward the side (forward side) opposite the internal space (surrounded space) of the surrounding portion

The restraining portion 43 has a plate-like shape and extends from rear end portions of the pair of opposing portions 421 of the surrounding portion 42 and a rear end portion of the bottom portion 423 of the surrounding portion 42 toward directions perpendicular to the forward/rearward direction (the leftward/rightward direction and the upward/downward direction). Notably, the restraining portion 43 is formed to extend to the outside of the surrounded space without entering the rearward opening of the surrounded space.

The fixing bracket 40 is disposed on the forward side of the ceramic heater 10 disposed in the housing 20. Specifically, as shown in FIGS. 3 and 4, the fixing bracket 40 is disposed in relation to the ceramic heater 10 such that the restraining portion 43 butts, from the forward side, against the flange portion 12 of the ceramic heater 10 disposed in the housing 20. At that time, the restraining portion 43 and the surrounding portion 42 of the fixing bracket 40 are disposed in the second space S2 of the housing 20. The base portion 111 of the circular tubular portion 11 of the ceramic heater 10 is located in the surrounded space surrounded by the surrounding portion 42 disposed in the second space S2. Meanwhile, the inlet passage portion 41 of the fixing bracket 40 protrudes toward the forward side from the second space S2 of the housing 20. In addition, the inlet passage portion 41 and the circular tubular portion 11 of the ceramic heater 10 are disposed to be coaxial with each other, the edge of a rear end opening of the inlet passage portion 41 and the edge of a forward end opening of the base portion 111 of the ceramic heater 10 are butted against each other, and the gap between them is sealed by an O-ring 82 (see FIG. 2). As a result, the space inside the inlet passage portion 41 and the space inside the base portion 111 communicate with each other. In addition, an inlet temperature sensor 71 is attached to the inlet passage portion 41. The inlet temperature sensor 71 detects the temperature of the liquid flowing inside the inlet passage portion 41 and sends a signal representing the detected temperature to the control circuit board 30.

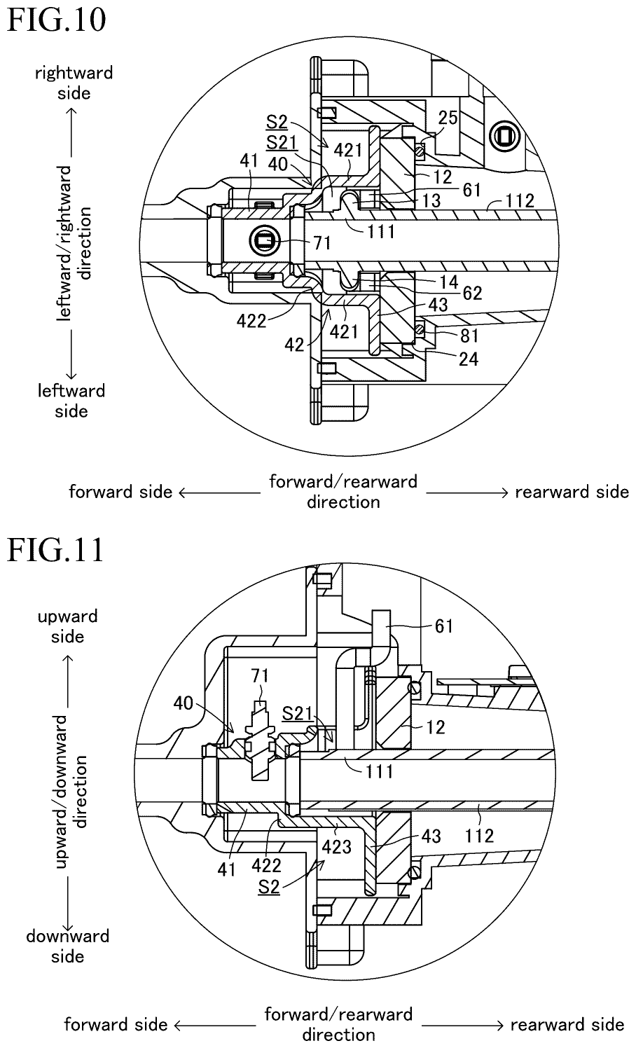

FIG. 10 is an enlarged view of a portion B of FIG. 3, and FIG. 11 is an enlarged view of a portion C of FIG. 4. As described above, the surrounding portion 42 of the fixing bracket 40 is disposed in the second space S2 of the housing 20. Accordingly, as shown in FIGS. 10 and 11, the surrounded space S21, which is the space surrounded by the surrounding portion 42, is defined in the second space S2. The surrounding portion 42 is configured to surround the base portion 111, the first electrode pad 13 and the second electrode pad 14 formed on the outer circumferential surface of the base portion 111, the first electricity conducting member 61 connected, at its one end, to the first electrode pad 13, and the second electricity conducting member 62 connected, at its one end, to the second electrode pad 14. In other words, the base portion 111 of the ceramic heater 10, the first electrode pad 13, the second electrode pad 14, the first electricity conducting member 61, and the second electricity conducting member 62 are disposed in the surrounded space S21 surrounded by the surrounding portion 42. At that time, the pair of the opposing portions 421 of the surrounding portion 42 are disposed to face each other such that they are spaced in the leftward/rightward direction so as to cover the base portion 111 of the circular tubular portion 11 from opposite sides (the rightward side and the leftward side).

In addition, the restraining portion 43 of the fixing bracket 40 butts against the flange portion 12 of the ceramic heater 10. As a result, the rearward opening of the surrounded space S21 is closed by the flange portion 12. Moreover, the rear end of the inlet passage portion 41, which is open through the connecting portion 422 of the surrounding portion 42 is closed by the O-ring 82 and the forward end of the base portion 111 of the ceramic heater 10. Therefore, the connecting portion 422 is located on the forward side of the surrounded space S21 having an approximately cuboid-shape, the flange portion 12 is located on the rear side of the surrounded space S21, the pair of opposing portions 421 are located on the right and left sides of the surrounded space S21, and the bottom portion 423 is located on the lower side of the surrounded space S21. Namely, the approximately cuboid-shaped surrounded space S21 is surrounded by these wall members from five directions. Therefore, the surrounded space S21 communicates with the external space only on the upper side.

A potting agent, which serves as a seal member, is injected into the surrounded space S21. Since the surrounded space S21 communicates with the external space only on the upper side as described above, the potting agent is injected into the surrounded space S21 from the upper side, so that the potting agent is kept in the surrounded space S21 and does not leak out. When the potting agent injected into the surrounded space S21 solidifies, the members disposed in the surrounded space S21; specifically, the base portion 111 of the ceramic heater 10, the first electrode pad 13, the second electrode pad 14, the first electricity conducting member 61, and the second electricity conducting member 62 are embedded in the potting agent and sealed. Notably, the first electricity conducting member 61 and the second electricity conducting member 62 are partially embedded in the potting agent. Specifically, of the first electricity conducting member 61, a portion connected to the first electrode pad 13 and a portion near that portion are embedded in the potting agent (sealed). Similarly, of the second electricity conducting member 62, a portion connected to the second electrode pad 14 and a portion near that portion are embedded in the potting agent (sealed).

The potting agent used in the present embodiment is a potting agent whose main component is olefin-based resin. However, potting agents of other components may be used. For example, it is possible to use a potting agent whose main component is an epoxy resin (epoxy-based resin) or a special polymer containing a silyl group. However, potting agents containing silicone resin as a main component are not used.

As shown in FIGS. 1A, 1B, and 2, the inlet plate 50 has a inlet port 51, a bracket accommodating portion 52, and a cover portion 53. The inlet port 51 has the shape of a circular tube having an axis along the forward/rearward direction. A liquid to be heated by the heating apparatus 1 is supplied from the forward end of the inlet port 51. The rear end of the inlet port 51 is open through the bracket accommodating portion 52. The bracket accommodating portion 52 is formed into the shape of a bag so as to accommodate the inlet passage portion 41 of the fixing bracket 40 therein. The cover portion 53 extends from the rear end of the bracket accommodating portion 52. The cover portion 53 is formed into the shape of a flat plate having surfaces perpendicular to the forward/rearward direction such that its outline coincides with the outline of the forward end opening of the second space S2 (the electric power supply chamber 22) of the housing 20.

As shown in FIGS. 3 and 4, a peripheral portion of the cover portion 53 of the inlet plate 50 is butted against the forward end surfaces of the right-forward wall portion 221, the left-forward wall portion 222, the bottom wall portion 223, and the upper wall portion 224, which define the electric power supply chamber 22 of the housing 20. At that time, the inlet passage portion 41 of the fixing bracket 40 is accommodated in the bracket accommodating portion 52 of the inlet plate 50. The inlet passage portion 41 accommodated in the bracket accommodating portion 52 is disposed coaxially with the inlet port 51 of the inlet plate 50, the edge of the forward end opening of the inlet passage portion 41 is butted against the edge of the rear end opening of the inlet port 51, and the gap therebetween is sealed by an O-ring 83 (see FIG. 2). As a result, the internal space of the inlet port 51 and the internal space of the inlet passage portion 41 communicate with each other.

As shown in FIG. 2, the cover portion 53 has protrusions 531 protruding outward. The protrusions 531 are provided, along the outer circumference of the cover portion 53, at a plurality of locations in the circumferential direction. These protrusions 531 have circular holes which penetrate the protrusions 531 in the forward/rearward direction. In addition, the housing 20 has protrusions 226 protruding outward. The protrusions 226 are provided, along the edge of the forward end opening of the electric power supply chamber 22, at a plurality of locations in the circumferential direction. These protrusions 226 have threaded holes. These threaded holes are open to the forward surface of the protrusions 226 and extend rearward from the forward surface. The positions of the plurality of protrusions 531 coincide with the positions of the plurality of protrusions 226 as viewed in the forward/rearward direction when the outer peripheral portion of the cover portion 53 is butted against the forward end surfaces of the electric power supply chamber 22 (the right-forward wall portion 221, the left-forward wall portion 222, the bottom wall portion 223, and the upper wall portion 224) of the housing 20. Therefore, the circular holes formed in the protrusions 531 and the threaded holes formed in the protrusions 226 are coaxially disposed along the forward/rearward direction. Screws are inserted into the circular holes formed in the protrusions 531 and are screwed into the threaded holes of the protrusions 226, whereby the inlet plate 50 is attached to the housing 20, and the forward end opening of the second space S2 of the housing 20 is closed by the cover portion 53.

The screw fastening force generated when fixing the inlet plate 50 to the housing 20 acts on the fixing bracket 40 disposed on the rearward side of the inlet plate 50. As a result, the restraining portion 43 of the fixing bracket 40 is strongly pressed against the flange portion 12 of the ceramic heater 10, and the flange portion 12 of the ceramic heater 10 is strongly pressed against the seating surface 242 of the stepped wall portion 24 of the housing 20 via the O-ring 81. As a result of strongly butting of the restraining portion 43 of the fixing bracket 40 against the flange portion 12 as described above, the ceramic heater 10 is fixed to the housing 20, and the first space S1 and the second space S2 in the housing 20 are liquid tightly separated by the flange portion 12 and the O-ring 81.

As shown in FIG. 2, a connector connection portion 28 is formed on the right-rearward wall portion 231 of the housing 20. Electric wires for connecting the control circuit board 30 disposed in the third space S3 of the housing 20 to an external electronic device pass through the connector connection portion 28. In addition, as shown in FIG. 1A, the upper plate 70 for closing the upward side opening of the third space S3 of the housing 20 is attached to the housing 20.

The liquid, which is an object to be heated, is introduced into the heating apparatus 1 having the above-described structure through the inlet port 51 of the inlet plate 50. As indicated by arrows in FIG. 3, the liquid introduced to the inlet port 51 is supplied from the inlet port 51 to the inlet passage portion 41 of the fixing bracket 40 and then flows into the heating portion 112 of the circular tubular portion 11 of the ceramic heater 10 through the space inside the base portion 111 of the circular tubular portion 11. The liquid having flowed into the heating portion 112 flows from the forward side toward the rearward side in the space inside the heating portion 112, and flows out from the heating portion 112 through its rear end. The liquid having flowed out from the heating portion 112 flows into the first space S1. After reversing the flow direction at the end of the first space S1, the liquid flows from the rearward side toward the forward side in the space between the outer circumferential surface of the heating portion 112 and the inner circumferential surface of the peripheral wall portion 211 of the housing 20. The liquid having flowed from the rearward side toward the forward side in the first space S1 as described above flows out to the outlet passage portion 27 and is discharged to the outside from the outlet passage portion 27.

While the liquid flows inside the housing 20 of the heating apparatus 1 in the above-described manner, a predetermined voltage is applied between the first electricity conducting member 61 (the first electrode pad 13) and the second electricity conducting member 62 (the second electrode pad 14) from the control circuit board 30. As a result, the resistive heating element of the ceramic heater 10 is energized, and thus, the resistive heating element generates heat. As a result of the heat generation, the heating portion 112 of the ceramic heater 10 is heated. Accordingly, the liquid flowing inside the heating portion 112 and flowing through the space between the outer circumferential surface of the heating portion 112 and the inner circumferential surface of the peripheral wall portion 211; that is, the liquid flowing through the first space S1 of the housing 20 is heated by the heating portion 112. The liquid heated in this manner is discharged from the outlet passage portion 27.

The control circuit board 30 obtains, as an inlet temperature Tin, the temperature of the liquid introduced into the heating apparatus 1 on the basis of the signal received from the inlet temperature sensor 71, and obtains, as an outlet temperature Tout, the temperature of the liquid heated by the heating apparatus 1 on the basis of the signal received from the outlet temperature sensor 72. The control circuit board 30 controls the amount of electricity (output) supplied to the resistive heating element such that the outlet temperature Tout coincides with a target temperature T*. In this case, for example, by PI control based on the difference between the outlet temperature Tout and the target temperature T*, the energization of the resistive heating element can be controlled such that the outlet temperature Tout coincides with the target temperature T*.

While the heating apparatus 1 is heating the liquid, the temperature within the second space S2 in the housing 20 becomes high due to the influence of the heating of the liquid by the ceramic heater 10. In addition, the humidity within the second space S2 becomes high as a result of entry of water vapor in the air into the second space S2. Accordingly, during a period during which the heating apparatus 1 operates, the atmospheric state in the second space S2 is a high-temperature and high-humidity state. In the case where a predetermined voltage is applied between the first electricity conducting member 61 and the second electricity conducting member 62 disposed in the second space S2, where both of temperature and humidity are high, whereby a current flows through the resistive heating element, the possibility of occurrence of ion migration is high. In particular, ion migration is highly likely to occur between the first electricity conducting member 61 and the second electricity conducting member 62 for supplying electric power to the resistive heating element. If ion migration occurs between the first electricity conducting member 61 and the second electricity conducting member 62, the control circuit board 30 may be damaged due to a short circuit. Therefore, it is necessary to suppress the occurrence of ion migration between the first electricity conducting member 61 and the second electricity conducting member 62.

In the heating apparatus 1 according to the present embodiment, the potting agent is injected into the surrounded space S21 surrounded by the surrounding portion 42 of the fixing bracket 40 disposed in the second space S2. In other words, the surrounding space S21 surrounded by the surrounding portion 42 of the fixing bracket 40 disposed in the second space S2 is filled with the potting agent. Therefore, the members disposed in the surrounded space S21; specifically, the base portion 111 of the ceramic heater 10, the first electrode pad 13, the second electrode pad 14, the first electricity conducting member 61, and the second electricity conducting member 62, are embedded in the potting agent and sealed. Therefore, the air around these members is removed by the potting agent, whereby moisture around these members is removed. Furthermore, since the potting agent is formed of a material having high insulating performance and low hygroscopicity, ion migration does not occur inside the potting agent. Therefore, it is possible to suppress occurrence of ion migration between the first electricity conducting member 61 and the second electricity conducting member 62 embedded in the potting agent in the surrounded space S21.

In addition, since the potting agent is injected into the surrounded space S21, it is possible to secure, without fail, the isolation between the first electrode pad 13 and the second electrode pad 14 in the surrounded space S21 and the isolation between these electrode pads and the fixing bracket 40. Moreover, it is possible to fix the ceramic heater 10 and the fixing bracket 40 by the potting agent injected into the surrounded space S21.

Notably, since the first electricity conducting member 61 and the second electricity conducting member 62 extend from the surrounded space S21 toward the control circuit board 30, only the portions disposed in the surrounded space S21 are sealed by the potting agent, and portions located outside the surrounded space S21 are not embedded in the potting agent. However, ion migration is highly likely to occur in regions near the electrode pads 13 and 14 to which one end of the electricity conducting member 61 and one end of the electricity conducting member 62 are connected, respectively. Among portions of the first electricity conducting member 61, a portion connected to the first electrode pad 13 and a portion near that potion are disposed in the surrounded space S21. Similarly, among portions of the second electricity conducting member 62, a portion connected to the second electrode pad 14 and a portion near that potion are disposed in the surrounded space S21. Therefore, these portions are embedded in the potting agent and are sealed. Accordingly, by virtue of sealing of these portions by the potting agent, occurrence of ion migration cab be suppressed sufficiently.

Although the embodiment of the present disclosure has been described, the technique according to the present disclosure is not limited to the above-described embodiment. For example, in the above-described embodiment, there is shown an example in which a potting agent whose main component is olefin-based resin is used as a seal member injected into the surrounded space S21. However, a seal member other than the potting agent whose main component is olefin-based resin may be used, so long as the seal member has high insulating performance and low hygroscopicity and can be injected into the surrounded space S21. In the above-described embodiment, there is described that the seal member can suppress occurrence of ion migration. However, at the same time, the seal member can suppress occurrence of electrolytic corrosion of the sealed member and generation of whiskers of the sealed member. The surrounded space S21 is not required to be completely filled with the potting agent, and it is sufficient if the surrounded space S21 is filled with the potting agent to the extent that a portion where ion migration occurs is embedded. The control circuit board 30 may use the signal received from the inlet temperature sensor 71 for control of energization of the resistive heating element or other controls. The directions which are defined in the above-described embodiment so as to describe the structure of the heating apparatus 1 are mere examples, and the heating apparatus 1 can be operated in various orientations in actual use. In this way, the technology according to the present disclosure can be modified as long as it does not deviate from the scope of the present disclosure.

Furthermore, the present disclosure encompasses the following modes.
[1] A heating apparatus comprising:
   a ceramic heater including a tubular ceramic base body and a resistive heating element embedded in the ceramic base body, the ceramic heater having a base portion, on which a first electrode connected to one end of the resistive heating element and a second electrode connected to the other end of the resistive heating element are formed, and a heating portion heated by the resistive heating element;
   a first electricity conducting member connected to the first electrode;
   a second electricity conducting member connected to the second electrode; and
   a housing which accommodates the ceramic heater,
   wherein the housing has a first space for accommodating the heating portion and a second space for accommodating the base portion, and
   the second space is filled with a seal member.
[2] A heating apparatus described in the above paragraph [1], further comprising a fixing member for fixing the ceramic heater to the housing,
   wherein the fixing member has a surrounding portion which is disposed in the second space and is configured to surround the base portion, the first electricity conducting member, and the second electricity conducting member, and
   wherein a surrounded space, which is an internal space of the surrounding portion, is filled with the seal member.
[3] A heating apparatus described in the above paragraph [1] or [2], wherein the ceramic heater has a circular tubular portion in which the base portion and the heating portion are continuously formed in an axial direction, and a flange portion which extends outward in a radial direction of the circular tubular portion from a boundary between the base portion and the heating portion,
   wherein a stepped wall portion is provided between the first space and the second space of the housing, the stepped wall portion having a circular hole which establishes communication between the first space and the second space and has a diameter smaller than an outer diameter of the flange portion, and
   wherein the flange portion butts against the stepped wall portion, thereby separating the first space and the second space from each other.
[4] A heating apparatus described in the above paragraph [3], wherein the ceramic heater is disposed in the housing such that an axial direction of the circular tubular portion coincides with a first direction,
   wherein the surrounding portion has a pair of opposing portions disposed to face each other such that the opposing portions are spaced from each other in a second direction perpendicular to the first direction and cover the base portion from opposite sides, a connecting portion which connects together end portions of the opposing portions located on one side in the first direction, and a bottom portion which closes an opening surrounded by end portions of the pair of opposing portions and an end portion of the connecting portion, the end portions being located on one side in a third direction perpendicular to the first direction and the second direction, and
   wherein the surrounded space is a space surrounded by the pair of opposing portions, the connecting portion, and the bottom portion.
[5] A heating apparatus described in the above paragraph [4], wherein the fixing member has a restraining portion formed to extend in a direction perpendicular to the first direction from end portions of the pair of opposing portions and an end portion of the bottom portion, the end portions being located on the other side in the first direction, and
   wherein the ceramic heater is fixed by the fixing member as a result of butting of the restraining portion against the flange portion.
[6] A heating apparatus described in the above paragraph [4] or [5], wherein the fixing member has a tubular inlet passage portion having one end which is open through the connecting portion, the inlet passage portion extending in a direction opposite the surrounded space, and
   wherein the base portion disposed in the surrounded space is connected to one end of the inlet passage portion, whereby communication is established between an internal space of the inlet passage portion and an internal space of the base portion.
[7] A heating apparatus described in any of the above paragraphs [1] to [6], wherein the housing has a third space separated from the second space,
   wherein a control circuit board for controlling energization of the resistive heating element is disposed in the third space, and
   wherein the first electricity conducting member and the second electricity conducting member extend from the first electrode and the second electrode, respectively, toward the control circuit board, and their distal end portions are connected to the control circuit board.
[8] A heating apparatus described in any of the above paragraphs [1] to [7], wherein the housing has an outlet passage portion through which a medium flows out from the first space,
   wherein the heating apparatus comprises a first temperature sensor for detecting the temperature of the medium flowing through the inlet passage portion and a second temperature sensor for detecting the temperature of the medium flowing through the outlet passage portion, and
   wherein a signal representing the temperature detected by the first temperature sensor and a signal representing the temperature detected by the second temperature sensor are sent to the control circuit board.
[9] A heating apparatus described in any of the above paragraphs [1] to [8], wherein the seal member is a potting agent whose main component is an olefin-based resin, an epoxy-based resin, or a special polymer containing a silyl group.
[10] A heating apparatus described in any of the above paragraphs [1] to [9], wherein the heating apparatus is used to heat a medium flowing through a flow passage formed in an apparatus mounted in a vehicle.

What is claimed is:

1. A heating apparatus comprising:
a ceramic heater including a tubular ceramic base body and a resistive heating element embedded in the ceramic base body, the ceramic heater having a base portion, on which a first electrode connected to one end of the resistive heating element and a second electrode connected to the other end of the resistive heating element are formed, and a heating portion heated by the resistive heating element;
a first electricity conducting member connected to the first electrode;
a second electricity conducting member connected to the second electrode; and
a housing which accommodates the ceramic heater,
wherein the housing has a first space for accommodating the heating portion and a second space for accommodating the base portion, and
the second space is filled with a seal member.

2. A heating apparatus according to claim 1, further comprising a fixing member for fixing the ceramic heater to the housing,
wherein the fixing member has a surrounding portion which is disposed in the second space and is configured to surround the base portion, the first electricity conducting member, and the second electricity conducting member, and
wherein a surrounded space, which is an internal space of the surrounding portion, is filled with the seal member.

3. A heating apparatus according to claim 2, wherein the ceramic heater has a circular tubular portion in which the base portion and the heating portion are continuously formed in an axial direction, and a flange portion which extends outward in a radial direction of the circular tubular portion from a boundary between the base portion and the heating portion,
wherein a stepped wall portion is provided between the first space and the second space of the housing, the stepped wall portion having a circular hole which establishes communication between the first space and the second space and has a diameter smaller than an outer diameter of the flange portion, and
wherein the flange portion butts against the stepped wall portion, thereby separating the first space and the second space from each other.

4. A heating apparatus according to claim 3, wherein the ceramic heater is disposed in the housing such that an axial direction of the circular tubular portion coincides with a first direction,
wherein the surrounding portion has a pair of opposing portions disposed to face each other such that the opposing portions are spaced from each other in a second direction perpendicular to the first direction and cover the base portion from opposite sides, a connecting portion which connects together end portions of the opposing portions located on one side in the first direction, and a bottom portion which closes an opening surrounded by end portions of the pair of opposing portions and an end portion of the connecting portion, the end portions being located on one side in a third direction perpendicular to the first direction and the second direction, and
wherein the surrounded space is a space surrounded by the pair of opposing portions, the connecting portion, and the bottom portion.

5. A heating apparatus according to claim 4, wherein the fixing member has a restraining portion formed to extend in directions perpendicular to the first direction from end portions of the pair of opposing portions and an end portion of the bottom portion, the end portions being located on the other side in the first direction, and
wherein the ceramic heater is fixed by the fixing member as a result of butting of the restraining portion against the flange portion.

6. A heating apparatus according to claim 5, wherein the fixing member has a tubular inlet passage portion having one end which is open through the connecting portion, the inlet passage portion extending in a direction opposite the surrounded space, and
wherein the base portion disposed in the surrounded space is connected to one end of the inlet passage portion, whereby communication is established between an internal space of the inlet passage portion and an internal space of the base portion.

7. A heating apparatus according to claim 3, wherein the housing has a third space separated from the first space,
wherein a control circuit board for controlling energization of the resistive heating element is disposed in the third space, and
wherein the first electricity conducting member and the second electricity conducting member extend from the first electrode and the second electrode, respectively, toward the control circuit board, and their distal end portions are connected to the control circuit board.

8. A heating apparatus according to claim 7 wherein the housing has an outlet passage portion through which a medium flows out from the first space,
wherein the heating apparatus comprises a first temperature sensor for detecting the temperature of the medium flowing through the inlet passage portion and a second temperature sensor for detecting the temperature of the medium flowing through the outlet passage portion, and
wherein a signal representing the temperature detected by the first temperature sensor and a signal representing the temperature detected by the second temperature sensor are sent to the control circuit board.

9. A heating apparatus according to claim 3, wherein the seal member is a potting agent whose main component is an olefin-based resin, an epoxy-based resin, or a special polymer containing a silyl group.

10. A heating apparatus according to claim 1, wherein the heating apparatus is used to heat a medium flowing through a flow passage formed in an apparatus mounted in a vehicle.
